(19) United States
(12) Patent Application Publication
(10) Pub. No.: US 2005/0219037 A1
(43) Pub. Date: Oct. 6, 2005

(54) Cargo theft prevention method and system

(76) Inventor: Tao Huang, Burnaby (CA)

Correspondence Address: WILKINSON & GRIST, 6TH FLOOR, PRINCE'S BUILDING, CHATER ROAD, CENTRAL, HONG KONG, CN

(21) Appl. No.: 11/094,469

(22) Filed: Mar. 31, 2005

Related U.S. Application Data
(60) Provisional application No. 60/581,061, filed on Jun. 21, 2004.

(30) Foreign Application Priority Data
Apr. 2, 2004 (CN) 200410026752.1

(51) Int. Cl. G06F 7/04

(52) U.S. Cl. 340/5.73; 70/14; 340/5.9; 380/278; 340/5.5; 340/5.26

(57) ABSTRACT

A cargo theft prevention method is disclosed. According to the method, a security device for sealing a cargo container and a communication system capable of being in communication with a sealer and an unsealer are provided. A first code utilizing a first algorithm stored in the communication system is generated. A second code utilizing a second algorithm stored in the security device is generated. The second code is then examined when the security device is to be unsealed.

### REFERENCE TO RELATED APPLICATION

The present application claims the benefit of U.S. Provisional Application No. 60/581,061 filed Jun. 21, 2004 and entitled Cargo container E-Seal and E-Key delivery method, which is hereby incorporated by reference in its entirety. The present application also claims priority from Chinese Patent Application No. 200410026752.1 filed Apr. 2, 2004 and entitled Cargo container E-Seal and E-Key delivery method.

### FIELD OF THE INVENTION

The present invention relates to a theft prevention method and system. In particular, the present invention relates to a theft prevention method and system for cargo containers.

### BACKGROUND OF THE INVENTION

The commercial freight transportation market is enormous and continues to expand every year in both developed and developing countries all over the world. However, along with the growth of the freight carrier industry comes an alarming increase in the number of instances of cargo theft. Although cargo theft has always been a problem, it is increasing at a disproportionately high rate, to a level which is becoming unacceptable to the transportation industry and also to the cargo insurance carriers. Consequently, insurance premiums and deductibles are rising at an alarming rate.

Normally, the back doors of a cargo container close with one over-lapping the other, and the security device includes a metal hasp on the outside of the overlapping door which is manually rotated to a closed position securing both doors together. The rotating locking hasp can be secured in place by a bolt seal or padlock device, which can be opened using a metal key.

Taking cargo transportation using trucks as example, the truck driver typically carries the key of the cargo container. A problem with this conventional method of securing cargo is that the driver or thief has access to the cargo and has the opportunity to steal some or all of the cargo. Further, there is the possibility of the driver diverging from the intended course and taking the cargo to a non-approved area, such as to a competitor, to another state or country, or through an area where the risk of theft is greater. Therefore, it would be desirable to provide an improved system and method to prevent cargo theft.

### SUMMARY OF THE INVENTION

The present invention is directed to a cargo theft prevention method. In a broad aspect, a security device for sealing a cargo container and a communication system capable of being in communication with a sealer and at least one unsealer are provided. A first code utilizing a first algorithm stored in the communication system is generated. A second code utilizing a second algorithm stored in the security device is generated. The second code is then examined when the security device is to be unsealed.

In another aspect, a security device for sealing a cargo container and a communication system capable of being in communication with a sealer and at least one unsealer are provided. A first series of unsealing codes utilizing a first series of algorithms stored in the communication system is generated. A second series of unsealing codes utilizing a second series of algorithms stored in the security device is generated. One of the first series of unsealing codes is then compared with at least one of the second series unsealing codes when the security device is to be unsealed.

In another aspect, a security device for sealing a cargo container and a communication system capable of being in communication with a sealer and at least one unsealer are provided. A series of unsealing codes utilizing a series of encryption algorithms stored in the communication system is generated. An unsealing checking code utilizing a decryption algorithm stored in the security device is generated. The unsealing checking code is then examined when the security device is to be unsealed.

### BRIEF DESCRIPTION OF THE DRAWINGS

FIG. 1 shows a security device with a controller used on a cargo container in accordance with the present invention.

FIG. 2 shows components of the controller of the security device of FIG. 1.

FIG. 3 is a flow chart showing the steps of sealing the security device of FIG. 1 in accordance with the present invention.

FIG. 4 shows a communication system for delivering unsealing codes to unsealers in accordance with the present invention.

FIG. 5 is a flow chart showing the steps of generating and delivering the unsealing codes in accordance with the present invention.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practices. It is to be understood that other embodiments may be utilized and structural changes may be made without departing from the scope of the invention.

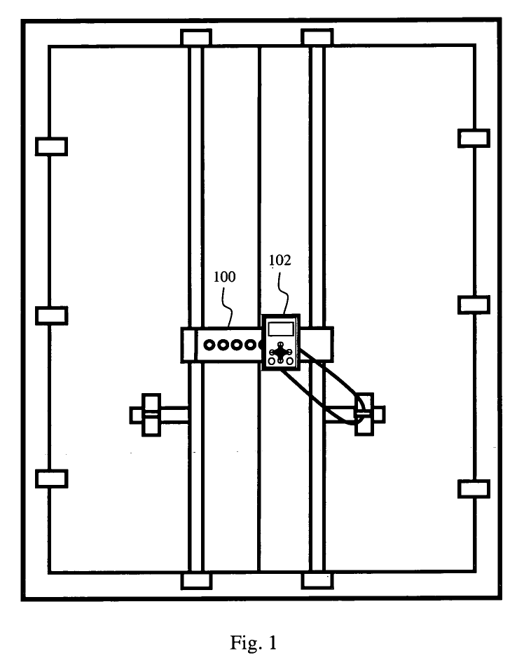

Referring now to FIG. 1, a cargo theft prevention system in accordance with present invention includes a security device (e.g., a lock assembly) 100 for sealing a cargo container. The security device 100 in the illustrated system includes a controller 102 and mechanical parts controlled by the controller 102.

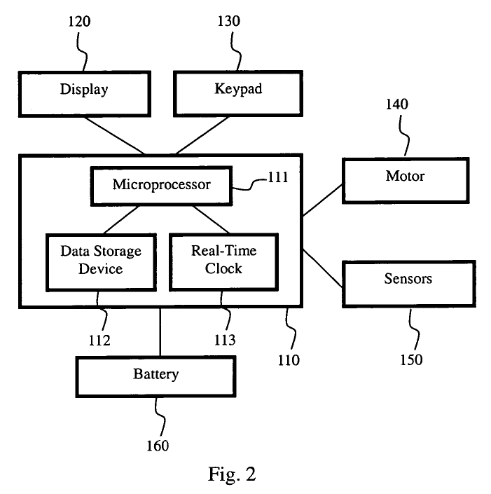

FIG. 2 shows a system diagram of the controller 102. The controller 102 in the illustrated embodiment may include a control board 110, a display (e.g., a LCD display) 120, a keypad 130, a motor 140, one or more sensors 150, and a battery 160. The control board 110 may include a processor (e.g., a microprocessor) 111, a data storage device (e.g., a flash memory) 112, and a real-time clock 113.

In the controller 102, the motor 140 is generally used to operate a locking pin to lock and unlock the security device 100. The sensors 150 are generally employed to measure the position of the locking pin and the operation of the motor. The battery 160 is generally used to provide electrical power to the security device 100.

The control board 110 is generally used to show information on the display 120, read the input from the keypad 130, receive locking pin position and motor operation signals from the sensors 150, control the motor 140 and generate a sealing code and unsealing codes/unsealing checking code which will be discussed in detail below.

The processor 111 is generally used to perform calculations and control the operation of the security device 100. The data storage device 112 is generally used to store the algorithms and parameters which are used to generate the sealing code and unsealing codes/unsealing checking code. The data storage device 112 is also used to keep the records of the sealer ID, sealing and unsealing date and time for each sealing and unsealing activity, etc. The details of the processor 111 and the data storage device 112 will be discussed below.

The display 120 is generally configured to display current time, the sealing code, the status of the security device 100 (e.g., locked, unlocked, unsealing times, tampered alert, battery state, etc.), the sealing and unsealing records, and the input information from the keypad 130. The keypad 130 is generally an interface adapted to power up the security device 100, seal and unseal the security device 100, send information to the security device 100, and obtain information from the security device 100.

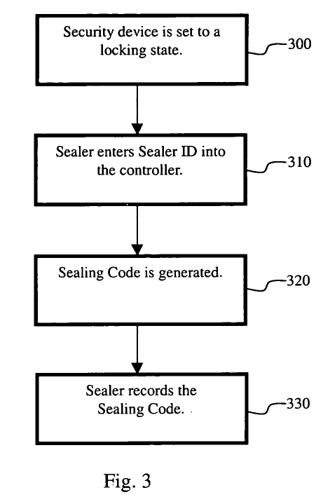

Referring now to FIG. 3, to seal the cargo container, a sealer powers up the security device 100 in the illustrated system and the locking pin of the security device 100 is then pushed into a locking state as shown in step 300. As used in the present application, the term “sealer” refers to a person (e.g., a consignor) who has authority to seal the cargo container. Generally, the cargo container is sealed by the sealer at a staring point of a journey.

The sensors 150 of the security device 100 can detect the locking pin in position and send a signal to the processor 111. The processor 111 can show information on the display 120 to ask the sealer to confirm the sealing activity. Optionally, the sealer can enter his or her unique ID (“sealer ID”) using the keypad 130, as indicated in step 310. The sealer ID can be a string of symbols, such as letters and/or numbers.

In step 320, the processor 111 can read the real-time clock 113 to obtain the current date and time and generate a sealing code based on the date and time and a unique ID assigned to the security device (“lock ID”) using an algorithm stored in the data storage device. The lock ID can be a string of symbols, such as letters and/or numbers. In the illustrated embodiment, the sealing code is a string of symbols (e.g., letters and/or numbers) displayed to the sealer. Optionally, the sealer ID can also be used with an algorithm to generate the sealing code in addition to the current date and time and the lock ID. The sealing code is then saved in the data storage device 112 and is shown on the display 120. Although the invention is described herein in connection with an exemplary algorithm and parameters (e.g., the current date and time, the lock ID and optionally the sealer ID) which are used to generate the sealing code, it is to be understood that other algorithm and parameters can also be used to generate the sealing code. For example, the sealing code can be generated from one or more of the parameters plus a random number. The sealing code can also have even/odd check bits for integrity check.

As indicated in step 330, the sealer then records (e.g. writes down, scans, etc.) the sealing code shown on the display 120 which generally includes the current date and time and the lock ID in accordance with an embodiment of the present invention. Optionally, the sealer can also record the Lock ID which is printed on the body of the security device.

After few seconds without any operation on the keypad, the processor 111 may turn the power off automatically. The power is normally provided to the real-time clock to keep the time running.

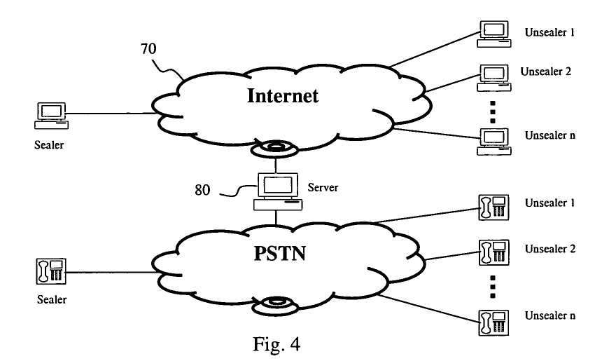

Referring now to FIG. 4, the cargo theft prevention system in accordance with present invention utilizes a communication system 70 where the sealer and an unsealer are able to be in communication with each other. As used in the present application, the term “unsealer” refers to a person (e.g., an inspector, an auditor or a consignee) who has authority to unseal the cargo container. Generally, the cargo container is unsealed by the unsealer during a journey or at the destination of the journey.

In the illustrated system, the sealer can communicate to the unsealer via the Internet or a PSTN network. The communication system 70 may provide a server 80 connected to the Internet and/or the PSTN network. Both the sealer and the unsealer are able to communicate with the server 80. Although the invention is described herein in connection with an exemplary communication system having the Internet and/or PSTN network, it is to be understood that other communication methods, including but not limited to Intranet, private switching telephone system, wireless LAN network, public wireless voice network, GPRS and 3G wireless data network, etc., can also be used.

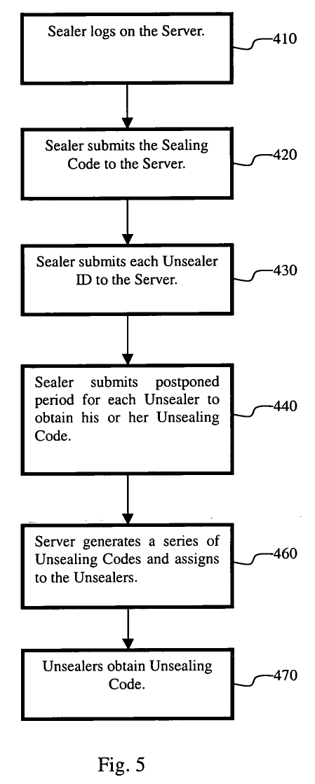

Referring to FIG. 5, after the sealer records the sealing code shown on the display 120, he or she submits the sealing code to the server 80. As indicated in step 410, the sealer logs on the server 80 via the Internet or the PSTN network in the illustrated system.

The sealer then submits the sealing code and each possible unsealer ID preferably in a sequential order to the server as indicated in steps 420 and 430. It is to be understood that there may be more than one unsealer IDs required for a cargo container transported from a starting point to a destination of a journey. For example, the first unsealer ID may be assigned to an inspector at the customs and the second unsealer ID may be assigned to the consignee at the destination. Optionally, the allowable postponed period for each unsealer to obtain his or her unsealing code is also submitted to the server as indicated in step 440. In other words, each unsealer can be assigned a pre-defined range of dates to obtain his or her unsealing code based on the date when the cargo container reaches the unsealer. As used in the present application, the term “unsealing code” refers to a string of symbols, such as letters and/or numbers, which can be inputted into the controller of the security device to unseal the cargo container. Although the invention is described herein in connection with exemplary steps that more than one unsealers (e.g., one or more inspectors and a consignee) unseal the cargo container, it is to be understood that there can be only one unsealer (e.g., a consignee) who unseals the cargo container at the destination. Only after the last unsealer unseals the cargo container, the entire sealing and unsealing activity is completed.

The server 80 can be configured to decode the sealing code to obtain information of the security device 100 (e.g., the lock ID) and find out the security device's unique parameter(s) saved in the server 80. The server 80 can also decode the sealing code to generate a record including sealing date and time, lock ID, sealer ID, date and time when the sealer logs on the server 80, etc. The record can be saved in the server 80.

The server 80 then generate a series of unsealing codes using one or more algorithms stored in the server 80, as indicated in step 460. Each unsealing code is available to its corresponding unsealer.

The following are a first series of exemplary algorithms which can be used by the server 80:
Unsealing_Code_{—}1_Generated_by_Server=(P1*Sealing_Code+P2)mod P3;
Unsealing_Code_{—}2_Generated_by_server=(P1*Unsealing_Code_{—}1_Generated_by_Server+P2)mod P3;
Unsealing_Code_M_Generated_by_Server=(P1*Unsealing_Code_(M−1)_Generated_by_Server+P3)mod P3
Unsealing_Code_(N-1)_Generated_by_Server=(P1*Unsealing_Code_(N-2)Generated_by_Server+P3)mod P3; and
Unsealing_Code_N_Generated_by_Server=(P1*Unsealing_Code_(N-1)_Generated_by_Server+P3) mod P3; where
Unsealing_Code_{—}1_Generated_by_Server to
Unsealing_Code_N_Generated_by_Server are a series of unsealing codes generated by the server 80;
P1 is the security device's first parameter which may be unique to the security device;
P2 is the security device's second parameter which may be unique to the security device;
P3 is the security device's third parameter which may be unique to the security device; and
at least one of the parameters P1, P2 and P3 is unique to the security device.

Although the invention is described herein in connection with exemplary algorithms with three parameters, it is to be understood that other algorithms with one or more parameters unique to the security device can also be used.

The following are a second series of exemplary algorithms, which uses DES encryption method to encrypt the sealing code:
Unsealing_Code_{—}1_Generated_by_Server=DES{Sealing_Code, P};
Unsealing_Code_{—}2_Generated_by_server=DES{(Sealing_Code+1), P};
Unsealing_Code_{—}3_Generated_by_server=DES{(Sealing_Code+2), P};
Unsealing_Code_M_Generated_by_Server=DES{(Sealing_Code+(M−1)), P}
Unsealing_Code_(N-1)_Generated_by_Server=DES{(Sealing_Code+N-2)), P}; and
Unsealing_Code_N_Generated_by_Server=DES{(Sealing_Code+(N-1)), P}; where
Unsealing_Code_{—}1_Generated_by_Server to
Unsealing_Code_N_Generated_by_Server are a series of unsealing codes generated by the server 80; and
P is the security device's unique parameter.

In the illustrated system, each of the unsealing codes is available to its corresponding unsealer preferably at the pre-defined range of dates. For example,
Unsealing_Code_{—}1_Generated_by_Server is available to the first unsealer before
Unsealing_Code_{—}2_Generated_by_Server is available to the second unsealer, while
Unsealing_Code_{—}3_Generated_by_Server is available to the third unsealer after
Unsealing_Code_{—}1_Generated_by_Server and
Unsealing_Code_{—}2_Generated_by_Server are available to the first and second unsealers.

Each unsealer can be notified that the unsealing code has been delivered to his or her mailbox in the server 80 by existing or future communication means, including but not limited to email, SMS, telephone call, etc., as described in step 460. The unsealer, after receiving the notification, logs on the server 80, and obtains the unsealing code from his or her exclusive mailbox, as indicated in step 470. The server 80 can generate a record for each unsealing code retrieval activity for future investigation if necessary.

Alternatively, after the unsealing codes are generated by the server 80, they can be delivered directly to the unsealers via email, SMS or other communication means.

To unseal the cargo container, the unsealer powers up the controller of the security device in the illustrated system. The sealing code and the status of the security device 100 (e.g., locked, unlocked, unsealing times, tampered alert, battery state, etc.) can be shown on the display 120. The unsealer can use the keypad of the controller to select the “unseal” menu. The processor can show information on the display 120 to ask the unsealer to input his or her unsealing code to unseal the security device. The unsealer then inputs the unsealing code into the controller.

The processor 111 of the security device also generates a series of unsealing codes using one or more algorithms stored in the data storage device.

The following are a first series of exemplary algorithms which can be used by the processor 111. These algorithms correspond to the first series of exemplary algorithms used by the server 80.
Unsealing_Code_{—}1_Generated_by_Processor=(P1*Sealing_Code+P2)mod P3;
Unsealing_Code_{—}2_Generated_by_Processor=(P1*Unsealing_Code_{—}1_Generated_by_Processor+P2)mod P3;
Unsealing_Code_M_Generated_by_Processor=(P1*Unsealing_Code_(M−1)_Generated_by_Processor+P3)mod P3;
Unsealing_Code_(N-1l)_Generated_by_Processor=(P1*Unsealing_Code_(N-2)_Generated_by_Processor+P3)mod P3;
Unsealing_Code_N_Generated_by_Processor=(P1*Unsealing_Code(N-1)_Generated_by_Processor+P3)mod P3; where
Unsealing_Code_{—}1_Generated_by_Processor to
Unsealing_Code_N_Generated_by_Processor are a series of unsealing codes generated by the processor of the security device;
P1 is the security device's first parameter which may be unique to the security device;
P2 is the security device's second parameter which may be unique to the security device;
P3 is the security device's third parameter which may be unique-to the security device; and
at least one of the parameters P1, P2 and P3 is unique to the security device.

Although the invention is described herein in connection with exemplary algorithms with three parameters, it is to be understood that other algorithms with one or more parameters unique to the security device can also be used.

The processor 111 then compares the unsealing code inputted by the unsealer with one or more one-time emergency unsealing codes and each unsealing code generated by the security device. As used in the present application, the “one-time emergency unsealing code” refers to an unsealing code which is used to unseal the security device during emergency situations. The emergency unsealing codes are generally set up by the manufacturer and is generally saved in the data storage device. Normally, each emergency unsealing code can only be used once. If the unsealing code inputted by the unsealer corresponds to one of the one-time emergency unsealing codes or one of the unsealing code generated by the security device in a valid sequential order, the processor 111 sends a signal to the motor 140 to allow the locking pin to be released. The data storage device also records the unsealing activity. As used in the present application, the term “valid sequential order” refers to a situation when an unsealing code inputted by the unsealer satisfies a predefined criterion that the security device can be unsealed (e.g., a unsealing code inputted by the unsealer is equal to one of the unsealing codes generated by the security device) and such unsealing code together with other unsealing codes generated after such unsealing code have not been used yet.

For example, if the unsealing code inputted by the unsealer matches the M^{th} unsealing code generated by the security device and no unsealing record shows that the M^{th} unsealing code and other unsealing codes generated after the M^{th} unsealing code (e.g., the (M+1)^{th} and/or the (M+2)^{th}) have been used before, the M^{th} unsealing code inputted by the unsealer is valid. If the unsealing code inputted by the unsealer matches the M^{th} unsealing code generated by the security device and no unsealing record shows that the M^{th} unsealing code has been used before, but the (M+1)^{th} and/or (M+2)^{th} unsealing code have been used already, the M^{th} unsealing code inputted by the unsealer is not valid. If the unsealing code inputted by the unsealer matches the M^{th} unsealing code generated by the security device and no unsealing record shows that the M^{th} unsealing code has been used before, but other unsealing codes generated before the M^{th} unsealing code (e.g., the (M−1)^{th} and/or (M−3)^{th} unsealing code) have not been used yet, the M^{th} unsealing code inputted by the unsealer is still valid.

Although the algorithm and the parameters in the server are equal to those in the security device as described above, it is to be understood that the algorithms and the parameters in the server are not necessarily equal to those in the security device.

The following is an exemplary algorithm which can be used by the processor 111. The algorithm utilized DES decryption method to decrypt the inputted unsealing code and generate an unsealing checking code. The algorithm corresponds to the second series of exemplary algorithms used by the server 80.
Unsealing_Checking_Code_M_Generated_by_Processor=DES_INV{Unsealing_Code_M_Generated_by_Server, P};
   Where
Unsealing_Checking_Code_M_Generated_by_Processor is the M^{th} unsealing checking code
generated by the processor of the security device;
1<=M<=N; and
P is the security device's unique parameter.

As used in the present application, the “unsealing checking code” refers to a string of symbols (e.g., letters and/or numbers) generated and used by the processor to examine whether the inputted unsealing code is valid or not. In the illustrated embodiment, the unsealing checking code is a decrypted unsealing code. The processor 111 then compares the inputted unsealing code with one or more one-time emergency unsealing codes. If the inputted unsealing code matches one of the one-time emergency unsealing codes, the processor 111 sends a signal to the motor 140 to allow the locking pin to be released. If the inputted unsealing code does not match one of the one-time emergency unsealing codes, the processor 111 compares the unsealing checking code generated by the processor with (Sealing_code), (Sealing_Code+1), (Sealing_Code+2), . . . , (Sealing_Code+M), . . . , (Sealing_Code+(N-2)), (Sealing_Code+(N-1)). If the unsealing checking code matches one of the codes listed herein and the unsealing code is in a valid sequential order, the processor 111 sends a signal to the motor 140 to allow the locking pin to be released.

For example, if the unsealing checking code decrypted from the M^{th} unsealing code inputted by the unsealer equals to (Sealing_Code+(M−1)) and no unsealing record shows that other unsealing codes generated after the M^{th} unsealing code (e.g., the (M+1)^{th} and/or the (M+2)^{th}) have been used before, the M^{th} unsealing code inputted by the unsealer is valid. If unsealing record shows that other unsealing codes generated after the M^{th} unsealing code (e.g., the (M+1)^{th} and/or the (M+2)^{th}) have been used before, the M^{th} unsealing code inputted by the unsealer is invalid. If no unsealing record shows that the M^{th} unsealing code has been used before, but other unsealing codes generated before the M^{th} unsealing code (e.g., the (M−1)^{th} and/or (M−3)^{th} unsealing code) have not been used yet, the M^{th} unsealing code inputted by the unsealer is still valid.

In the illustrated system, the processor 111 checks whether the unsealing code entered by the unsealer is the last unsealing code generated by the security device. If the unsealing code entered by the unsealer is the last unsealing code, the processor 111 ends this unsealing sequence loop and will be ready to generate a new sealing code when the security device is reused. If the unsealing code entered by the unsealer is not the last unsealing code generated by the security device, the processor 111 will be ready to accept a new unsealing activity in the same sequence loop after the unsealer reseals the security device.

Optionally, at any time after the security device is sealed, any person can audit the sealing activities of the security device. The person can use the keypad 130 to obtain the sealing and unsealing activities, such as sealing date and time, sealer ID, number of authorized unseal activities, sequence of unseal activities, etc.

The cargo theft prevention system in accordance with the present invention provides a number of advantages. For example, using the system, the only parties throughout the shipment chain who can access the unsealing code to unseal the container are the authorized unsealers. Even the person who seals the container cannot access to the unsealing code. Further, the cargo theft prevention system provides a mechanism for unsealing the cargo container at inspection points using a series of unique unsealing codes which are used in sequence along the journey.

While the present invention has been shown and described with particular references to a preferred embodiments thereof, it should be noted that various other changes or modifications may be made without departing from the scope of the present invention.

1. A cargo theft prevention method comprising:
(A) providing a security device for sealing a cargo container;
(B) providing a communication system capable of being in communication with a sealer and an unsealer;
(C) generating a first code utilizing a first algorithm which is stored in the communication system;
(D) generating a second code utilizing a second algorithm which is stored in the security device; and
(E) examining the second code when the security device is to be unsealed.

2. The cargo theft prevention method of claim 1 wherein the communication system comprises a server capable of being in communication with the sealer and the unsealer.

3. The cargo theft prevention method of claim 1 further comprising:
(a) generating a sealing code; and
(b) submitting the sealing code to the communication system prior to step (C).

4. The cargo theft prevention method of claim 1 further comprising communicating the first code to the unsealer prior to the step (D).

5. The cargo theft prevention method of claim 1 further comprising submitting the first code to the security device prior to the step (D).

6. The cargo theft prevention method of claim 1 wherein:
the step (C) comprises generating a first unsealing code utilizing the first algorithm; and
the step (D) comprises generating a second unsealing code utilizing the second algorithm.

7. The cargo theft prevention method of claim 6 further comprising generating a sealing code prior to the step (C) and wherein:
the step (C) comprises generating the first unsealing code utilizing the sealing code; and
the step (D) comprises generating the second unsealing code utilizing the sealing code.

8. The cargo theft prevention method of claim 6 wherein the first algorithm is equal to the second algorithm.

9. The cargo theft prevention method of claim 6 wherein the step (E) comprises comparing the first unsealing code with the second unsealing code.

10. The cargo theft prevention method of claim 9 further comprising unsealing the security device when the first unsealing code matches the second unsealing code in accordance with a predefined criterion after the step (E).

11. The cargo theft-prevention method of claim 6 wherein:
the step (C) comprises generating the first unsealing code utilizing a first parameter unique to the security device; and
the step (D) comprises generating the second unsealing code utilizing a second parameter unique to the security device.

12. The cargo theft prevention method of claim 11 wherein the first parameter is equal to the second parameter.

13. The cargo theft prevention method of claim 1 wherein:
the step (C) comprises generating a unsealing code utilizing an encryption algorithm; and
the step (D) comprises generating a unsealing checking code utilizing a decryption algorithm.

14. The cargo theft prevention method of claim 13 further comprising generating a sealing code prior to the step (C) and wherein:
the step (C) comprises generating the unsealing code by encrypting the sealing code; and
the step (D) comprises generating the unsealing checking code by decrypting the unsealing code.

15. The cargo theft prevention method of claim 13 wherein the unsealing checking code is a decrypted unsealing code.

16. The cargo theft prevention method of claim 13 wherein:
the step (C) comprises generating the unsealing code utilizing a first parameter unique to the security device; and
the step (D) comprises generating the unsealing checking code utilizing a second parameter unique to the security device.

17. The cargo theft prevention method of claim 16 wherein the first parameter is equal to the second parameter.

18. The cargo theft prevention method of claim 13 further comprising unsealing the security device when the unsealing checking code satisfies a predefined criterion after the step (E).

19. A cargo theft prevention method for comprising:
(A) providing a security device for sealing a cargo container;
(B) providing a communication system capable of being in communication with a sealer and at least one unsealer;
(C) generating a first series of unsealing codes utilizing a first series of algorithms which is stored in the communication system;
(D) generating a second series of unsealing codes utilizing a second series of algorithms which is stored in the security device; and
(E) comparing one of the first series of unsealing codes with at least one of the second series unsealing codes when the security device is to be unsealed.

20. A cargo theft prevention method for comprising:
(A) providing a security device for sealing a cargo container;
(B) providing a communication system capable of being in communication with a sealer and at least one unsealer;
(C) generating a series of unsealing codes utilizing a series of encryption algorithms which is stored in the communication system;
(D) generating an unsealing checking code utilizing a decryption algorithm which is stored in the security device; and
(E) examining the unsealing checking code when the security device is to be unsealed.
